(19) United States
(12) Patent Application Publication
(10) Pub. No.: US 2022/0321478 A1
(43) Pub. Date: Oct. 6, 2022

(54) MANAGEMENT OF PORT CONGESTION

(71) Applicant: Intel Corporation, Santa Clara, CA (US)

(72) Inventors: Anil VASUDEVAN, Portland, OR (US); Grzegorz JERECZEK, Gdansk (PL); Parthasarathy SARANGAM, Portland, OR (US)

(21) Appl. No.: 17/838,703

(22) Filed: Jun. 13, 2022

(51) Int. Cl. H04L 47/122; H04L 47/129; H04L 47/52

(52) U.S. Cl. CPC H04L 47/122; H04L 47/129; H04L 47/52

(57) ABSTRACT

Examples described herein relate to a switch comprising: circuitry to detect congestion at a target port and re-direct one or more packets directed to the target port to one or more other ports for re-circulation via one or more uncongested ports based on congestion at the target port. In some examples, the circuitry is to identify the target port in the re-directed one or more packets. In some examples, the circuitry is to transmit a congestion level indicator to the one or more other ports based on a congestion level of the target port.

### BACKGROUND

Leaf spine fabric topologies are used in data center networks to provide multiple path choices from the leaf to spine for a given destination. The leaf layer includes switches that forward traffic from servers and connect directly into a spine switch. The spine switch can interconnect leaf switches. A chosen path can depend on a scheme used to pick an egress port from the leaf switch (e.g., equal-cost multipath (ECMP)).

Incast is an occurrence of packet traffic from multiple sources causing an overload of traffic at an egress port. Incast can occur on downstream leaf switch ports when multiple spine switch ports to the leaf switch concurrently send traffic to the same downstream leaf switch port. Incast can cause queues to fill up on the downstream leaf switch port, resulting in increased latency of traffic through the leaf switch port.

Reorder Resilient Transport (RRT) is a manner to load balance traffic across available egress ports that can reduce occurrence of incast from upstream leaf switches ports connected to spin switches. Incast detection can cause signaling of sender(s) to slow down packet transmission to the port subject to incast (e.g., Data Center Transmission Control Protocol (DCTCP), Swift). Signaling back to the sender makes the reaction time to a congestion signal a function of round-trip times (RTTs). When queues build up and exceed certain fullness levels, congestion signals are sent or inferred, which reduces packet throughput and increases latency. As incast increases, if available queue capacity is exceeded, packets can be dropped, resulting in more loss of throughput, increased jitter, and higher latencies.

### BRIEF DESCRIPTION OF THE DRAWINGS

FIG. 1 depicts an example system.

FIG. 2 depicts an example capabilities exchange.

FIG. 3A depicts an example network interface device system.

FIG. 3B depicts an example system.

FIG. 4 depicts an example system.

FIGS. 5A and 5B depict example processes.

FIG. 6 depicts an example network interface.

FIG. 7 depicts an example system.

FIG. 8 depicts an example system.

FIG. 9 depicts an example switch.

### DETAILED DESCRIPTION

At least to attempt to reduce occurrence of incast or congestion at a port, and potentially reduce a number of packet drops or potentially reduce a likelihood of reduction of throughput, based on congestion at one or more queues that provide packets to a target port of a switch, the switch can re-direct packets from the target port to one or more non-congested ports of the switch. Congestion at a port can be caused by one or more queues that provide packets to the port being full, exceeding a level that is identified as full, or overflowing. Congestion at the port can be detected based on fullness levels of one or more queues that provide packets to the port. The switch can provide a packet burst tolerant disaggregated incast absorption system that load balances incast absorption among switch ports on a leaf node. The switch can mark packets transferred to one or more network interface devices and associated servers or systems as non-terminating and to be forwarded to the switch. The one or more non-congested ports of the switch can transfer packets to one or more network interface devices and associated servers or systems for buffering. For example, servers and systems can include distributed queues, buffers, storage nodes, and/or memory pools. The one or more network interface devices and associated servers or systems can store and manage re-directed packets. The one or more network interface devices and associated servers can buffer the packets and then redirect the packets to the switch based on reduction in congestion at one or more queues that provide packets to the target port or incast subsiding at the target port. The switch can notify the one or more non-congested ports and associated network interface devices and servers or systems when the target port is free from incast or subject to reduced congestion and ready to transmit packets. Packets that arrive out of transmit order can be reordered at a destination network interface device connected to the target port. For example, Reorder Resilient Transport (RRT) can be applied at the destination node to reorder packets received out of order. A system can provide a near lossless Ethernet fabric for the data center at scale.

In some examples, the one or more non-congested ports can be associated with one or more backup switch ports and backup network interface devices to reduce interference with a target network interface device port for incast handling. One or more servers can be allocated to process re-directed packets to reduce interference with other servers for incast handling. One or more connected network interface devices can be allocated to perform incast absorption to drain incast overflow.

In some examples, network interface devices or servers can delay the signaling of congestion to transmitters or not signal congestion, such as for transient congestion. Delaying the congestion signaling for transient congestion by leveraging additional memory on the servers, can allow maintaining throughput and reduced average and tail latencies.

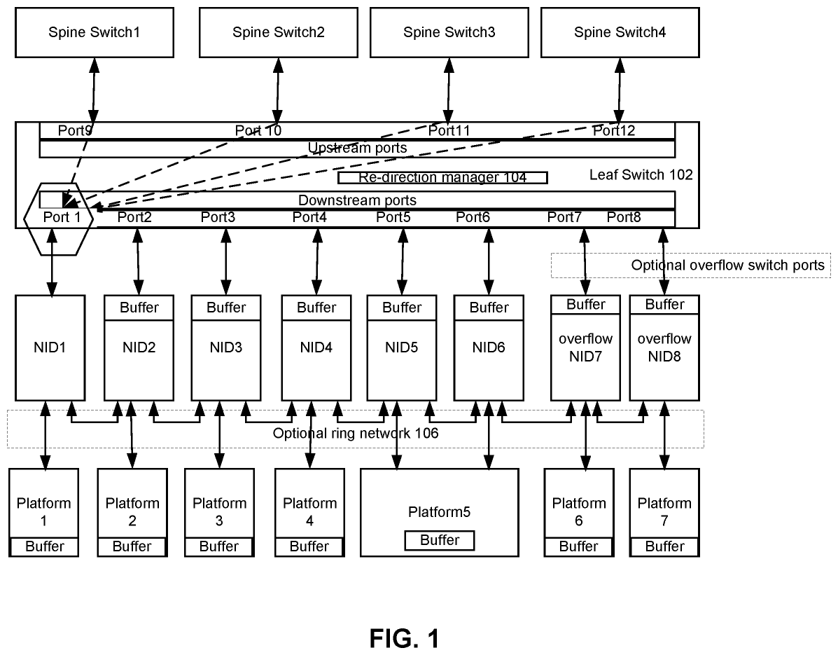

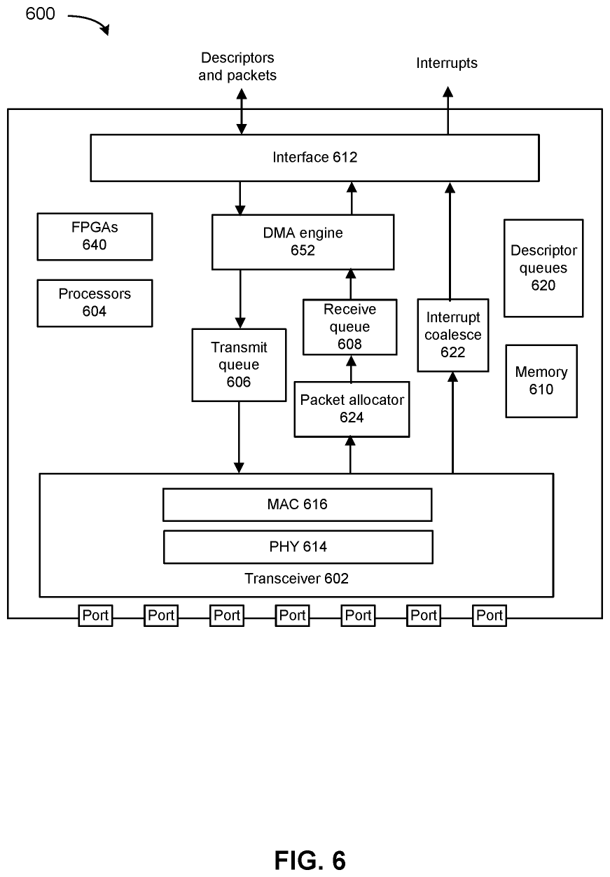

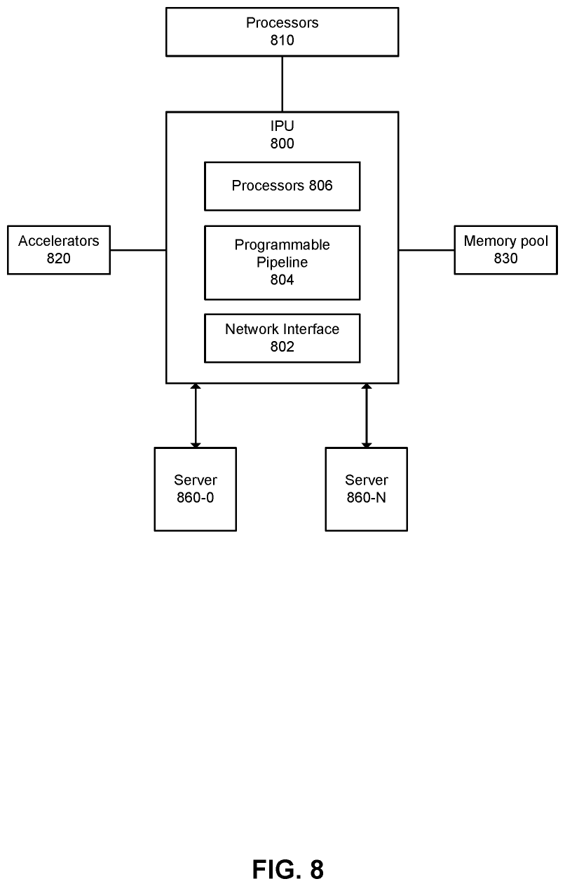

FIG. 1 depicts an example system. In this example, four spine switches (e.g., spine switch 1 through 4) provide packets to ports 9-12 of leaf switch 102. Leaf switch 102 includes 8 downstream ports (e.g., ports 1-8) coupled to respective network interface devices (NIDs) 1-8. Servers or host systems (e.g., one or more of platforms 1-7)) can be coupled to one or more of NIDs 1-8. In some examples, switch 102 can refer to one or more of: a router, forwarding element, infrastructure processing unit (IPU), or data processing unit (DPU). Switch 102 can include one or more elements of the system of FIGS. 6, 8, and/or 9. In some examples, a network interface device can refer to one or more of: a network interface controller (NIC), a remote direct memory access (RDMA)-enabled NIC, SmartNIC, router, switch, forwarding element, IPU, or DPU. At least one of platforms 1-7 can include one or more of: one or more storage devices, one or more memory devices, one or more memory pools, or one or more host systems.

One or more NIDs and switch 102 could exchange messages that advertise respective capabilities to perform absorption of re-directed packets and re-transmission of re-directed packets to switch 102.

In a leaf spine data center fabric, link congestion can occur due to one or more of the following: incast on downstream ports, equal-cost multipath (ECMP) hash collisions on upstream ports, or oversubscription ratios of downstream to upstream ports on the leaf nodes being too high. Switch 102 can be configured with congestion levels of downstream switch ports 1-8 at which switch 102 is to take at least one remedial action to reduce a chance of overrun of a buffer that could lead to packets being dropped. When the congestion level is met or exceeded at a target downstream port, switch 102 can perform at least one remedial action. The at least one remedial action can include forwarding packets intended for the target downstream port to one or more other downstream egress ports that are not congested. Switch 102 can forward packets among available non-congested ports based on round-robin, hash, selection of a port that supports forwarding packets to a destination network interface device through a side-band or ring network 106, current load levels of non-congested ports, or others. In some examples, packets received by switch 102 and directed to a congested target port after the port is identified as congested can be re-directed to one or more non-congested ports. In some examples, packets received by switch 102 that are already stored are in a queue associated with the congested port can be re-directed to one or more non-congested ports.

In some examples, re-direction manager 104 can allocate more memory space to one or more queues that provide packets to the congested target port. For example, memory space allocated to one or more queues that provide packets to one or more non-congested target ports can be re-allocated to one or more queues that provide packets to the congested target port.

Switch 102 can tag redirected packets with an indication in at least one header field of the packets that a destination of such packets is not a re-directed port but a particular target port number. For example, the tag can be placed in the header field with a no-redirect value would indicate that this packet is for the target port, virtual local area network (VLAN) header, Virtual Extensible LAN (VxLAN) header, or other header field and indicate that the packet is re-directed and not intended to be sent to the port of egress. In some examples, a priority level in specified in a header field can indicate redirection of the packet and one or more NIDs and switch 102 can negotiate or be configured with the one or more priority levels that indicate a packet was redirected.

In some examples, switch 102 can write a time stamp or priority value that indicates a priority of the re-directed packet relative to other re-directed packets. For non-tunneled and tunneled L3 packets (e.g., VxLAN with routing), the traffic to downstream ports can be marked by switch 102. Switch 102 can mark packets that are re-directed but not keep track of a port to which the re-directed packet was sent, although in some examples, switch 102 can track ports that were sent re-directed packets for load balancing or other purposes. Although examples are described with respect to leaf switches, other network interface devices can be used such as a forwarding element.

Ports that receive the re-directed packet traffic can provide the re-directed packet traffic to one or more queues or buffers, either on a platform (e.g., one or more of platforms 1-7) or potentially on a NID. Queues or buffers can provide temporary packet absorption arising from congestion or incast, beyond what switch 102 provides. One or more network interface device and/or platforms 1-7 can subsequently forward or re-circulate the re-directed packets to switch 102 to forward to the target egress port. Re-direction manager 104 (e.g., based on Data Plane Development Kit (DPDK), OpenDataPlane or Linux® Address Family of the eXpress Data Path (AF_XDP) (e.g., a Linux socket type built upon the Extended Berkeley Packet Filter (eBPF) and eXpress Data Path (XDP) technology)) executed by a processor of switch 102 can instruct a NID and/or platform that received re-directed packets when to send such packets back to switch 102. Re-direction manager 104 can track ports that received re-directed packets, in some examples, to determine which absorber ports to send an instruction to send such packets back to switch 102. Re-direction manager 104 can determine that a congested target port is no longer congested and notify these absorber ports that the target egress port is able to receive the re-directed packets. In some examples, a NID that received a re-directed packet can execute a pause timer at or after receipt of a re-directed packet and at expiration of the timer, NID can send the re-directed packet back to switch 102 to attempt to transmit through the target egress port.

In some examples, side channel ring network 106 can connect one or more absorber NIDs through NID ports and can forward re-directed packets to a target NID connected to a target egress port, and bypass the congested target egress port of switch 102.

In some examples, one or more NIDs or platforms can be allocated to receive re-directed packets and buffer such re-directed packets. One or more absorber NIDs prioritize packets that are to be transmitted from the NIDs by forwarding or origination from a connected host server over transmission of recirculated packets. One or more absorber NIDs prioritize packets that are to be transmitted from the NIDs can implement a de-prioritization of recirculated traffic, such as linearly or exponentially.

An amount of available buffer memory on switch 102 could be less than what would be available on the servers to absorb transient large incasts on multiple ports. In some examples, ports can be configured to share entire buffer memory with the congested port.

In an example scenario, port 1 of switch 102 is to receive packets from switches 1-4. Initially, target egress port 1 is not congested and a level of congestion or incast is set at 4 packets. Switch 1 sends packet 1 to port 1. Switches 2 and 3 send one packet each to port 1. Switch 4 sending a packet to port 1 causes port 1 to reach a level of congestion or incast. When congestion occurs on a target egress port 1, switch 102 re-directs packets sent to port 1 to one or more other available ports that are not congested. For example, switch 102 can forward packets to absorber port 2 and/or port 3, which in this example could be up to 5 absorber ports (e.g., port 2 to port 6). For example, switch 1 sends packet 2 to port 1 and switch 2 sends packet 2 to port 1.

Network interface device 2 can receive re-directed packet from port 2. Network interface device 2 can allocate queues of network interface device 2 so that traffic of a particular application utilizes such allocated queues to store re-directed packet traffic. For example, queues of an Intel® Application Device Queue (ADQ) can be allocated solely to store re-directed packet traffic. For example, one or more queues can be allocated solely to store re-directed packet traffic, even if left empty if there are no re-directed packet traffic. In some examples, one or more queues of a network interface device are allocated for re-directed packet traffic.

In some examples, based on expiration of a timer after receipt of the re-directed packet, network interface device 2 can transmit the re-directed packet to switch 102 to send to a target port. In some examples, switch 102 can explicitly indicate to absorber ports that port 1 is uncongested drop threshold free. The notification that a port 1 is no longer congested can be sent as an indication in packet header forwarded to the absorber ports. The notification that port 1 is no longer congested can be sent as a message in a packet with a priority reserved re-directed traffic. At or after a packet queue level of port 1 reduces below the congestion level, leaf switch can permit packets to be sent to port 1. For example, packets received from one or more of switches 1-4 or from a network interface device that provides the re-directed packets to leaf switch to send through port 1. In some examples, a scheduler for port 1 can prioritize packets that were re-directed over packets that were not re-directed.

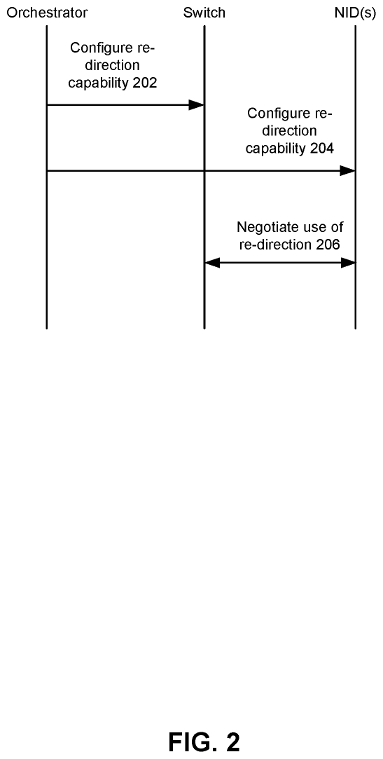

FIG. 2 depicts an example capabilities exchange. At 202 and 204, an orchestrator, administrator, operating system (OS), driver, or other software can configure respective switch and one or more network interface devices and/or platforms to (a) direct packets away from a congested target port to one or more uncongested ports and (b) one or more network interface devices and/or platforms re-direct packets to the switch to egress from the formerly congested target port or its destination network interface device.

At 206, one or more network interface devices and/or platforms and the leaf switch could exchange messages that advertise their respective capabilities to accept packet overflows and send packet overflows back to switch or to a destination network interface device by bypassing the switch.

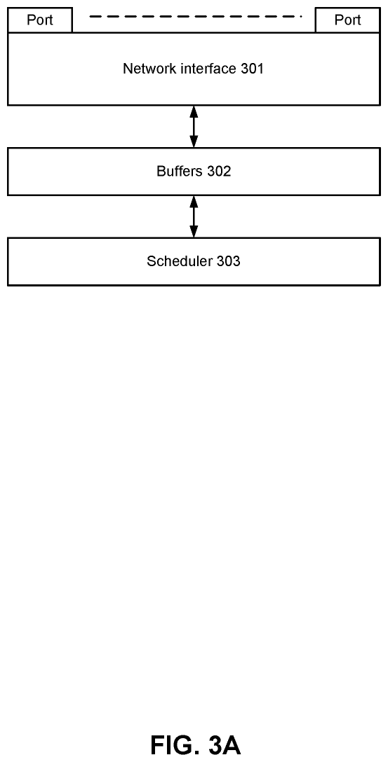

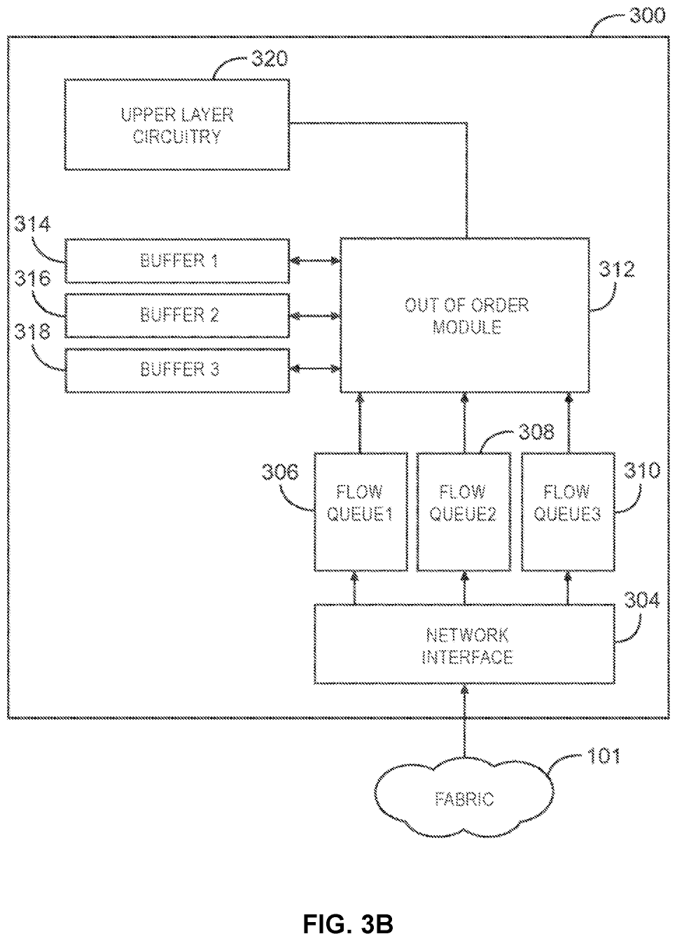

FIG. 3A depicts an example network interface device system. Network interface 301 can receive or transmit packets through one or more ports. Buffer 302 can store packets received from one or more ports, including re-directed packets. Buffer 302 can store packets to be transmitted through one or more ports. In some examples, some queues of buffer 302 are allocated for re-directed packet traffic.

Scheduler 303 can schedule re-directed packets for transmission from buffers 302 based on expiration of a timer after receiving a re-directed packet or after receiving an indication a target port is no longer congested or one or more re-directed packet can be transmitted to the switch. Scheduler 303 can prioritize transmission of re-directed packets through one or more ports to a switch or a destination network interface device. Scheduler 303 can modify headers of re-directed packets to identify a destination port as a target port in a switch from which the re-directed packets were sent.

In some examples, scheduler 303 can prioritize packets to be transmitted from a host over transmission of re-directed packet traffic. For example, an amount of bandwidth can be allocated to transmit re-directed packet traffic.

One or more ADQ queues can be assigned to exclusively store re-directed packets and/or packets with notifications that congestion of a target port has cleared. A device driver can identify re-directed packets based on storage in the one or more ADQ queues and cause the re-directed packets to be transmitted to the switch or destination NID. The device driver can poll for re-directed packets. A policy dependent rate limit can specify low end guaranteed and higher end transmit rate for re-directed traffic to balance prioritization of traffic originated from a host and transmission of re-directed traffic. This could be configured to prioritize local server to fabric traffic, as needed, to mitigate the congestion possibility noted above.

FIG. 3B depicts an example system to perform Reorder Resilient Transport (RRT) in a network interface device. For example, as described earlier herein, the data packets are put into flow queues 306, 308 or 310 based at least on the flow to which each data packet belongs, where a flow includes data packets with the same source port, destination port, protocol, IP source address, and IP destination address. The network interface 304 can store the data packets in sequential positions of the flow queues 306, 308, 310 in the order in which the data packets were received at the network interface 304. Once the network interface 304 stores the data packets for a flow in one of the flow queues 306, 308, or 310, then data packets for that flow can go into that same flow queue.

Out-of-order module 312 retrieves a first data packet having first packet order information from a first sequential position in the flow queue 306, 308 or 310. The out-of-order module 312 can be implemented in hardware circuitry, for example link layer circuitry, or in software. The out-of-order module 312 can then retrieve a second data packet having second packet order information from a second sequential position that is a next sequential position to the first sequential position in the flow queue 306, 308, or 310.

Out-of-order module 312 determines whether the first and second data packets are in sequence based on packet order information within the first and second data packets. Out-of-order module 312 can logically store the first data packet and the second data packet in a buffer 314, 316, 318 if the first packet order information and the second packet order information indicate that the first data packet and the second data packet were received out of order. In some embodiments, the flow queues 306, 308, or 310 themselves can include one of the buffers 314, 316, 318. As described earlier herein, packet order information, including first packet order information and second packet order information, indicate an order in which the first data packet and the second data packet were sent. The packet order information can include tags or other information or indicators that were provided by the source end station 108, for example within packet headers of each data packet. Further, the out-of-order module 312 can refrain from providing the first data packet and the second data packet to upper layer circuitry 320 (e.g., “network layer circuitry”) if the first packet order information and the second packet order information indicate that the first data packet and the second data packet were received out of order.

If the first packet order information and the second packet order information indicate that the first data packet and the second data packet were received in order, the out-of-order module 312 provides the first data packet and the second data packet to the upper layer circuitry 320 if the buffer 314, 316 or 318 is empty. Otherwise, if the buffer 314, 316 or 318 is not empty, the out-of-order module can store the contents of the buffer 314, 316 or 318 into sequential order and transmit the newly in-order buffer 314, 316, or 318 to upper layer circuitry 320.

Otherwise, if the first data packet and the second data packet were out of sequence, the out-of-order module 312 can inspect packet order information of retrieved data packets, and logically store data packets in the buffer 314, 316 or 318 if respective packet order information indicates that the data packets are still out of sequence (i.e., if there is a “missing” data packet).

Out-of-order module 312 may distinguish data packets that were dropped from data packets that intentionally arrive out-of-order using algorithms based on time, counters, or other criteria, or combinations of criteria in various embodiments. For example, in some embodiments, the out-of-order module 312 maintains a counter to track the number of data packets that have been received out-of-order. When a data packet received is out of order, the out-of-order module 312 can increment the counter. The out-of-order module 312 continues to retrieve subsequent data packets, sequentially based on the sequential positions of the data packets, from the flow queue 306, 308, or 310. The out-of-order module 312 can inspect the packet order information of each subsequent retrieved data packet. If the missing data packet has not been retrieved, the out-of-order module 312 can continue to increment the counter, up to the counter limit.

Out-of-order module 312 may maintain a counter with a limit of “3.” In the illustrative example, the out-of-order module 312 retrieves a first data packet from a first sequential position in the flow queue 306, 308 or 310, and this first data packet includes first packet order information indicating a sequence number “3.” Next, the out-of-order module 312 retrieves a second data packet from a second sequential position in the flow queue 306, 308 or 310, and determines that the second data packet includes second packet order information indicating a sequence number “1.” At this point, the out-of-order module 312 has detected an out-of-order packet based on the first packet order information and the second packet order information, and the out-of-order module 312 can initialize a counter and logically store the first data packet and the second data packet in a buffer 314, 316 or 318. The out-of-order module 312 can continue retrieving data packets from sequential positions in the flow queue 306, 308, or 310 (up to three data packets in this illustrative example). The out-of-order module 312 can increment the counter after each retrieval that does not retrieve the missing data packet, and logically store the data packets in the buffer 314, 316 or 318. For example, if the third retrieved data packet includes third packet order information indicating a sequence number of “2,” then the missing data packet has been retrieved, although the buffer 314, 316 or 318 may need to be reordered before sending data packets from the buffer 314, 316 or 318 to upper layer circuitry 320. The out-of-order module 312 can reorder data packets in the corresponding buffer 314, 316 or 318 into a sequential order based on packet order information for the data packets in the buffer 314, 316 or 318, to generate a reordered buffer, and send the reordered buffer including reordered data packets to upper layer circuitry 320. Otherwise, if data packets are still missing when the counter exceeds a counter limit, the out-of-order module 312 can reorder the contents of the buffer 314, 316 or 318 and transmit the contents to the upper layer circuitry 320, and the upper layer circuitry 320 can handle the data packets as though there were a dropped-packet situation or other error situation.

Out-of-order module 312 can use time-based criteria to determine when to send data packets to upper layer circuitry 320. In some examples, the out-of-order module 312 maintains a timer to keep track of an amount of time for which the out-of-order module 312 can wait for a missing data packet. In some examples, the timer can be based on a value for average round trip travel time for data packets between the source end station 108 and the device 300. However, embodiments are not limited to any particular value for the timer or to any particular method or criteria for determining the amount of time to wait for missing data packets. In at least some timer-based embodiments, the out-of-order module 312 initializes the timer to an initial value responsive to retrieving a data packet from the flow queue 306, 308 or 310. If the respective data packet was received out-of-order, the out-of-order module 312 logically stores that data packet in the buffer 314, 316 or 318. The out-of-order module 312 can then wait until the amount of time set for the timer for the missing data packet has expired. If the timer expires, the out-of-order module 312 can provide the data packets in the buffer 314, 316 or 318 to upper layer circuitry 320.

Out-of-order module 312 can combine timer-based and counter-based criteria for determining when data packets are out of order. For example, in data center environments experiencing bursty traffic, a timer may be used in addition to a counter, to prevent the out-of-order module 312 for waiting a very long time between bursts of traffic for any particular data packet to arrive.

Out-of-order module 312 may wait a certain amount of time before providing any out-of-order data packets to the upper layer circuitry 320. This amount of time can be based on the length of a standard interrupt cycle, or a multiplier of that length. Some embodiments provide a timer to wait for missing data packets for a maximum of, e.g., two interrupt cycles if an out of order data packet was observed, based on packet order information that was added to the data packet at the source end station 108. Given that data packets typically leave a source end station 108 at about the same time, in most non-error situations, two interrupt cycles should be sufficient time to receive missing data packets.

For embodiments in which flows are sent using the TCP protocol, in which case data packets are sent in order because the data packets are reassembled before getting to the TCP layer, the out-of-order module 312 or other software may obtain an indication, from the network interface 304 or the NIC driver (not shown in FIG. 3), of the number of queued data packets of the same flow. This information can provide the out-of-order module 312 (or processing software executing elsewhere in the device 300) with a value or estimate of the number of data packets that the out-of-order module 312 on how many data packets it can afford to wait to allow for reassembly without triggering the traditional out of order handling. The out-of-order module 312 can use that value or estimate for setting counters as described earlier herein.

In some examples, operations of detecting missing or out-of-order data packets may be performed at one module of the device 300, whereas reordering buffers 314, 316 or 318 may be performed by a separate module. For example, hardware at the network interface 304 may detect missing data packets and notify the out-of-order module 312 that the data packets are out of order prior to or after storing the data packets in one of the flow queues 306, 308 or 310, while software executing in the out-of-order module 312 or elsewhere in the device 300 may perform reordering of buffers 314, 316 or 318.

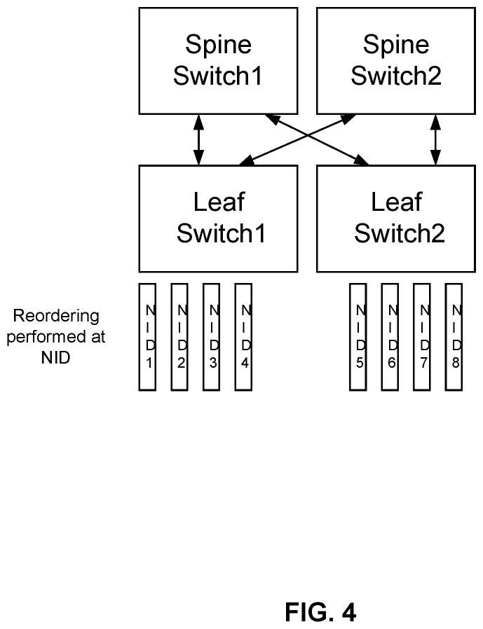

FIG. 4 depicts an example system. In cases where packets are received out of order at a receiver, such as re-directed packets from one or more ports, packet re-ordering can be performed before the packets are provided to the applications executing on a server. A destination network interface device and/or server can reorder received packets so that received packets are stored in order of transmit. For example, destination network interface device and/or server can perform RRT using technologies described at least with respect to FIG. 3A to perform reordering. Reliable transport or near lossless Ethernet communications can be supported despite incast or congestion at a port.

Returning to the example scenario above, switch 1 sends packets 1-3 to port 1, but due to congestion at port 1, leaf switch re-directs packets 2 and 3 to other absorber egress ports. After network interface devices associated with the absorber egress ports transmit packets 2 and 3 back to leaf switch 1 to transmit out of port 1, network interface device coupled to port 1 receives the packet 3 and then packet 2 and reorders packets 1-3 from switch 1.

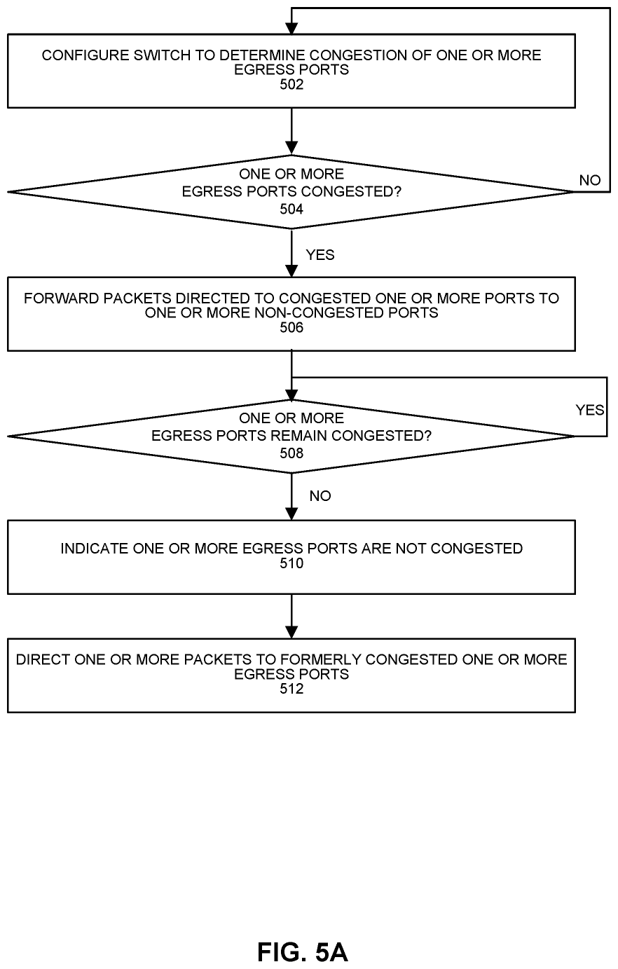

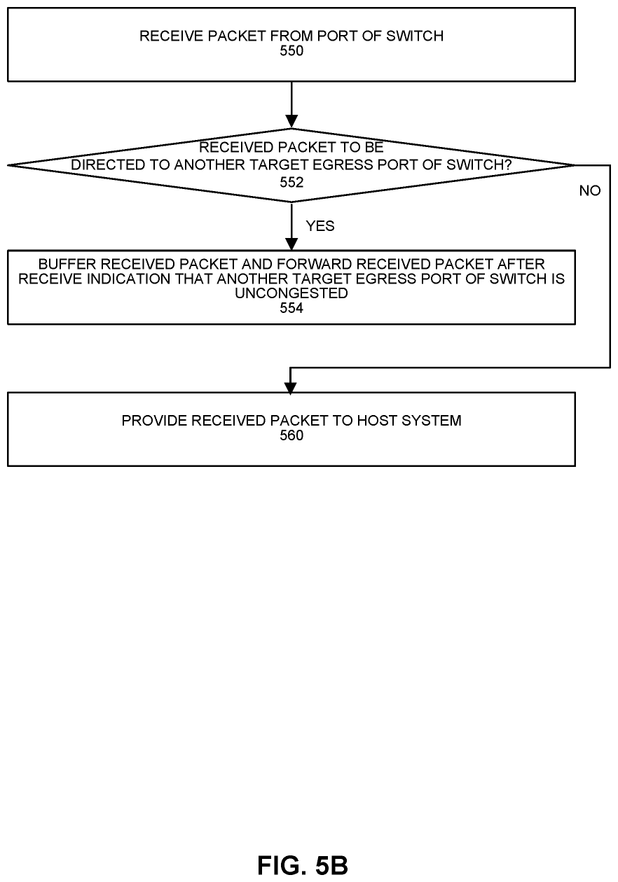

FIG. 5A depicts an example process. At 502, a switch can be configured to monitor congestion of one or more egress ports. At 504, a determination can be made if the one or more egress ports are congested. Based on detection of congestion at the one or more egress ports, the process can proceed to 506. Based on no detection of congestion at the one or more egress ports, the process can repeat 502.

At 506, the switch can cause packets to be forwarded to one or more uncongested egress ports. The switch can mark such forwarded packets as to be re-sent to the switch and identify that the utilized egress port differs from a target egress port.

At 508, the switch can be configured to monitor for reduction of congestion of the congested one or more egress ports and a determination can be made if the congested one or more egress ports are not congested. Based on detection of congestion at the one or more egress ports, the process can proceed to 510. Based on no detection of congestion at the one or more egress ports, the process can repeat 508.

At 510, the switch can indicate to devices connected to the one or more uncongested egress ports that one or more egress ports are not congested. In some examples, devices include network interface devices and/or host systems that buffer forwarded packets. At 512, the switch can direct packets to the one or more egress ports identified as not congested. For example, packets can include packets received from devices that sent forwarded packets back to switch to be transmitted to or from the formerly congested one or more egress ports.

FIG. 5B depicts an example process. At 550, a network interface device can receive a packet from an egress port of a switch. At 552, the network interface device can determine if the packet is received from an egress port of the switch from which the packet is to transmitted. For example, the packet can include an indication that the packet is to be transmitted from a target egress port that is different than the egress port from which the packet was received. If the packet is to be transmitted from a target egress port that is different than the egress port from which the packet was received, the process can proceed to 554. If the packet was received from an egress port from which the packet is to transmitted, the process can proceed to 560.

At 554, the network interface device can buffer the received packet and forward the packet to a switch based on receipt of an indication the target egress port of the packet is available to transmit the packet. The packet can be buffered in memory of the network interface device or a host system.

At 560, the network interface device can provide the packet for access by a host system as the packet destination is the host system coupled to the network interface device.

FIG. 6 depicts an example network interface device. In some examples, processors 604 and/or FPGAs 640 can be configured to perform buffering of re-directed packets directed to a congested target port and transmission of re-directed packets to the target port after congestion lessens or based on a command to transmit the re-directed packets to the target port, as described herein.

Some examples of network interface 600 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be one or more of: combination of: a processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 604.

Processors 604 can include a programmable processing pipeline that is programmable by Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 604 and/or FPGAs 640 can be configured to perform event detection and action.

Packet allocator 624 can provide distribution of received packets for processing by multiple CPUs or cores using receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit traffic manager can schedule transmission of packets from transmit queue 606. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with or based at least in part on PCI, PCIe, PCI-x, Serial ATA, and/or USB (although other interconnection standards may be used), or proprietary variations thereof.

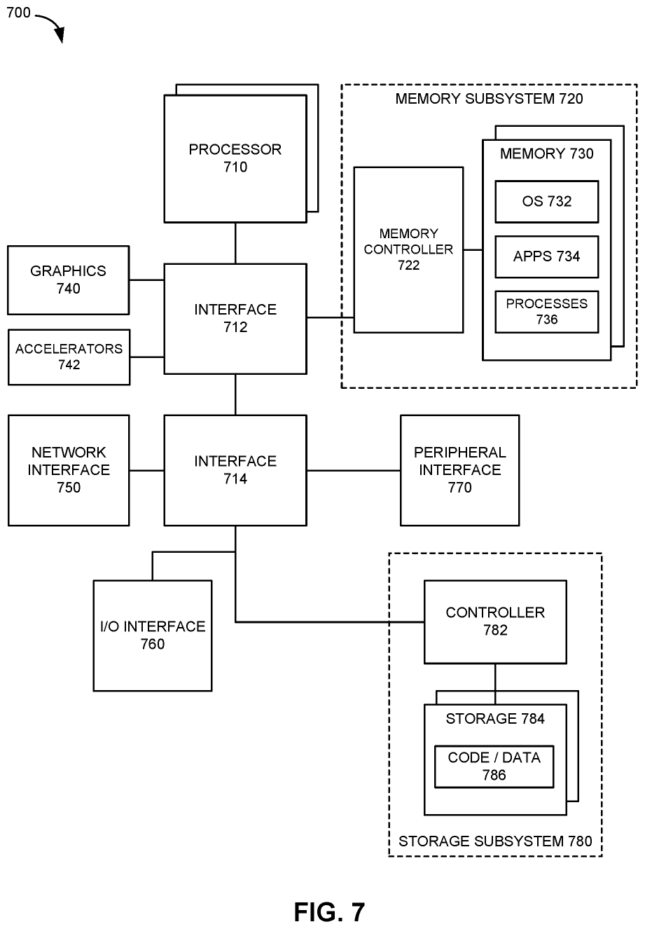

FIG. 7 depicts an example computing system. Components of system 700 (e.g., processor 710, accelerators 742, network interface 750, and so forth) can be configured to perform buffering of re-directed packets directed to a congested target port and transmission of re-directed packets to the target port after congestion lessens or based on a command to transmit the re-directed packets to the target port, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Network interface 750 can include one or more of: a network interface controller (NIC), a remote direct memory access (RDMA)-enabled NIC, SmartNIC, router, switch, or network-attached appliance. Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network that provides die-to-die communications; chip-to-chip communications; circuit board-to-circuit board communications; and/or package-to-package communications.

FIG. 8 depicts an example system. In this system, IPU 800 manages performance of one or more processes using one or more of processors 806, processors 810, accelerators 820, memory pool 830, or servers 840-0 to 840-N, where N is an integer of 1 or more. In some examples, processors 806 of IPU 800 can execute one or more processes, applications, VMs, containers, microservices, and so forth that request performance of workloads by one or more of: processors 810, accelerators 820, memory pool 830, and/or servers 840-0 to 840-N. IPU 800 can utilize network interface 802 or one or more device interfaces to communicate with processors 810, accelerators 820, memory pool 830, and/or servers 840-0 to 840-N. IPU 800 can utilize programmable pipeline 804 to process packets that are to be transmitted from network interface 802 or packets received from network interface 802. Programmable pipeline 804 and/or processors 806 can be configured to perform buffering of re-directed packets directed to a congested target port and transmission of re-directed packets to the target port after congestion lessens or based on a command to transmit the re-directed packets to the target port, as described herein.

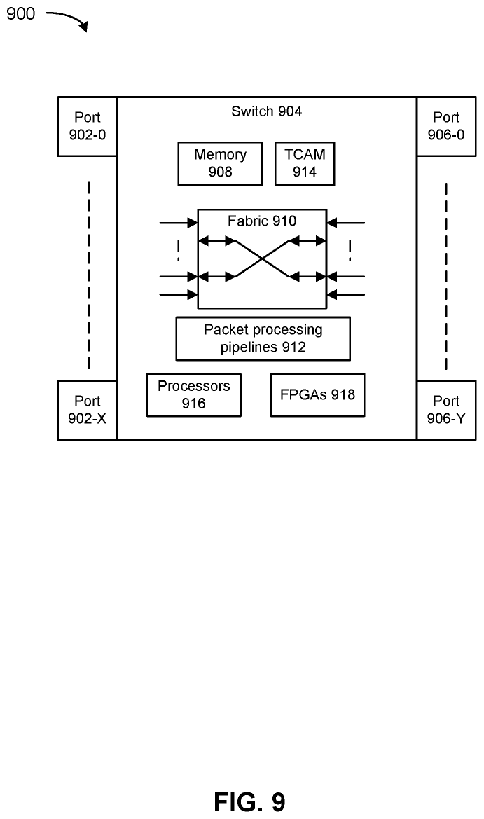

FIG. 9 depicts an example switch. Various device and processor resources in the switch can be programmed to perform buffering of re-directed packets directed to a congested target port and transmission of re-directed packets to the target port after congestion lessens or based on a command to transmit the re-directed packets to the target port, as described herein. Switch can receive a single packet from the source and sends one copy to one of the recipients. Switch 904 can route packets or frames of any format or in accordance with any specification from any port 902-0 to 902-X to any of ports 906-0 to 906-Y (or vice versa). Any of ports 902-0 to 902-X can be connected to a network of one or more interconnected devices. Similarly, any of ports 906-0 to 906-Y can be connected to a network of one or more interconnected devices.

In some examples, switch fabric 910 can provide routing of packets from one or more ingress ports for processing prior to egress from switch 904. Switch fabric 910 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 908 can be configured to store packets received at ports prior to egress from one or more ports. Packet processing pipelines 912 can determine which port to transfer packets or frames to using a table that maps packet characteristics with an associated output port. Packet processing pipelines 912 can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines 912 can implement access control list (ACL) or packet drops due to queue overflow.

Packet processing pipelines 912 can be configured or programmed using languages based on one or more of: P4, SONiC, C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

Packet processing pipelines 912 can be configured to perform buffering of re-directed packets directed to a congested target port and transmission of re-directed packets to the target port after congestion lessens or based on a command to transmit the re-directed packets to the target port, as described herein. Configuration of operation of packet processing pipelines 912, including its data plane, can be programmed using example programming languages and manners described herein. Processors 916 and FPGAs 918 can be utilized for packet processing or modification. In some examples, processors 916 can execute a virtual switch to provide virtual machine-to-virtual machine communications for virtual machines (or other VEEs) in a same server or among different servers.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a switch comprising: circuitry to detect congestion at a target port and re-direct one or more packets directed to the target port to one or more other ports for re-circulation via one or more uncongested ports based on congestion at the target port.

Example 2 includes one or more examples, wherein the circuitry is to identify the target port in the re-directed one or more packets.

Example 3 includes one or more examples, wherein the circuitry is to transmit a congestion level indicator to the one or more other ports based on a congestion level of the target port.

Example 4 includes one or more examples, wherein the one or more other ports are connected to one or more devices and wherein the one or more devices are to buffer the re-directed one or more packets.

Example 5 includes one or more examples, wherein the one or more devices comprise one or more of: one or more network interface devices, one or more other ports accelerator devices, one or more storage devices, one or more memory devices, one or more host systems.

Example 6 includes one or more examples, wherein the one or more network interface devices includes one or more of: a network interface controller (NIC), a remote direct memory access (RDMA)-enabled NIC, SmartNIC, data processing unit (DPU), infrastructure processing unit (IPU), router, switch, or network-attached appliance.

Example 7 includes one or more examples, wherein the one or more devices are to transmit the re-directed one or more packets to the switch based on an indication from the switch.

Example 8 includes one or more examples, wherein the switch is to receive the re-directed one or more packets and direct the re-directed one or more packets to the target port based on a congestion level of the target port.

Example 9 includes one or more examples, and includes a computer-readable medium, comprising instructions stored thereon, that if executed by one or more processors, cause the one or more processors to: configure a switch to: detect congestion at a target port based on a level of fullness of one or more queues that provide packets to the target port and based on congestion at the target port, re-direct one or more packets directed to the target port to one or more other ports for re-circulation via one or more uncongested ports.

Example 10 includes one or more examples, and includes instructions stored thereon, that if executed by one or more processors, cause the one or more processors to: configure the switch to identify the target port in the re-directed one or more packets.

Example 11 includes one or more examples, and includes instructions stored thereon, that if executed by one or more processors, cause the one or more processors to: configure the switch to transmit a congestion level indicator to the one or more other ports based on a congestion level of the target port.

Example 12 includes one or more examples, wherein the one or more other ports are connected to one or more devices and wherein the one or more devices are to buffer the re-directed one or more packets.

Example 13 includes one or more examples, wherein the one or more devices comprise one or more of: one or more network interface devices, one or more other ports accelerator devices, one or more storage devices, one or more memory devices, one or more host systems.

Example 14 includes one or more examples, and includes instructions stored thereon, that if executed by one or more processors, cause the one or more processors to: configure the switch to receive the re-directed one or more packets and direct the re-directed one or more packets to the target port based on a congestion level of the target port.

Example 15 includes one or more examples, and includes a method comprising: detecting congestion at a target port and re-direct one or more packets directed to the target port to one or more other ports for re-circulation via one or more uncongested ports based on congestion at the target port.

Example 16 includes one or more examples, and includes identifying the target port in the re-directed one or more packets.

Example 17 includes one or more examples, and includes transmitting a congestion level indicator to the one or more other ports based on a congestion level of the target port.

Example 18 includes one or more examples, wherein the one or more other ports are connected to one or more devices and wherein the one or more devices are to buffer the re-directed one or more packets.

Example 19 includes one or more examples, wherein the one or more devices comprise one or more of: one or more network interface devices, one or more other ports accelerator devices, one or more storage devices, one or more memory devices, one or more host systems.

Example 20 includes one or more examples, and includes receiving the re-directed one or more packets and directing the re-directed one or more packets to the target port based on a congestion level of the target port.

Example 21 includes one or more examples, and includes an apparatus that includes: a switch comprising: circuitry to: based on receipt of an indication of congestion at a target port, provide at least one packet to a different port than a destination port of the at least one packet and direct the at least one packet to the target port, after transmission through the different port.

Example 22 includes one or more examples, wherein the different port comprises a port with a lower congestion level than that of the target port.

Example 23 includes one or more examples, wherein the circuitry is to direct the at least one packet to the target port, after transmission through the different port and after receipt of the at least one packet from a device connected to the different port.

What is claimed is:

1. An apparatus comprising:
a switch comprising:
circuitry to detect congestion at a target port and re-direct one or more packets directed to the target port to one or more other ports for re-circulation via one or more uncongested ports based on congestion at the target port.

2. The apparatus of claim 1, wherein the circuitry is to identify the target port in the re-directed one or more packets.

3. The apparatus of claim 1, wherein the circuitry is to transmit a congestion level indicator to the one or more other ports based on a congestion level of the target port.

4. The apparatus of claim 1, wherein the one or more other ports are connected to one or more devices and wherein the one or more devices are to buffer the re-directed one or more packets.

5. The apparatus of claim 4, wherein the one or more devices comprise one or more of: one or more network interface devices, one or more other ports accelerator devices, one or more storage devices, one or more memory devices, one or more host systems.

6. The apparatus of claim 5, wherein the one or more network interface devices includes one or more of: a network interface controller (NIC), a remote direct memory access (RDMA)-enabled NIC, SmartNIC, data processing unit (DPU), infrastructure processing unit (IPU), router, switch, or network-attached appliance.

7. The apparatus of claim 4, wherein the one or more devices are to transmit the re-directed one or more packets to the switch based on an indication from the switch.

8. The apparatus of claim 1, wherein the switch is to receive the re-directed one or more packets and direct the re-directed one or more packets to the target port based on a congestion level of the target port.

9. A computer-readable medium, comprising instructions stored thereon, that if executed by one or more processors, cause the one or more processors to:
configure a switch to:
detect congestion at a target port based on a level of fullness of one or more queues that provide packets to the target port and
based on congestion at the target port, re-direct one or more packets directed to the target port to one or more other ports for re-circulation via one or more uncongested ports.

10. The computer-readable medium of claim 9, comprising instructions stored thereon, that if executed by one or more processors, cause the one or more processors to:
configure the switch to identify the target port in the re-directed one or more packets.

11. The computer-readable medium of claim 9, comprising instructions stored thereon, that if executed by one or more processors, cause the one or more processors to:
configure the switch to transmit a congestion level indicator to the one or more other ports based on a congestion level of the target port.

12. The computer-readable medium of claim 9, wherein the one or more other ports are connected to one or more devices and wherein the one or more devices are to buffer the re-directed one or more packets.

13. The computer-readable medium of claim 12, wherein the one or more devices comprise one or more of: one or more network interface devices, one or more other ports accelerator devices, one or more storage devices, one or more memory devices, one or more host systems.

14. The computer-readable medium of claim 9, comprising instructions stored thereon, that if executed by one or more processors, cause the one or more processors to:
configure the switch to receive the re-directed one or more packets and direct the re-directed one or more packets to the target port based on a congestion level of the target port.

15. A method comprising:
detecting congestion at a target port and re-direct one or more packets directed to the target port to one or more other ports for re-circulation via one or more uncongested ports based on congestion at the target port.

16. The method of claim 15, comprising:
identifying the target port in the re-directed one or more packets.

17. The method of claim 15, comprising:
transmitting a congestion level indicator to the one or more other ports based on a congestion level of the target port.

18. The method of claim 15, wherein the one or more other ports are connected to one or more devices and wherein the one or more devices are to buffer the re-directed one or more packets.

19. The method of claim 18, wherein the one or more devices comprise one or more of: one or more network interface devices, one or more other ports accelerator devices, one or more storage devices, one or more memory devices, one or more host systems.

20. The method of claim 15, comprising:
receiving the re-directed one or more packets and directing the re-directed one or more packets to the target port based on a congestion level of the target port.

21. An apparatus comprising:
a switch comprising:
circuitry to:
based on receipt of an indication of congestion at a target port, provide at least one packet to a different port than a destination port of the at least one packet and
direct the at least one packet to the target port, after transmission through the different port.

22. The apparatus of claim 21, wherein the different port comprises a port with a lower congestion level than that of the target port.

23. The apparatus of claim 21, wherein the circuitry is to direct the at least one packet to the target port, after transmission through the different port and after receipt of the at least one packet from a device connected to the different port.
